(19) United States
(12) Patent Application Publication
(10) Pub. No.: US 2017/0154341 A1
(43) Pub. Date: Jun. 1, 2017

(54) SYSTEM FOR GENERATING EMPLOYEE CONFIRMATION SIGNATURE PAGES

(71) Applicant: Douglas GILBERTSON, Red Deer (CA)

(72) Inventor: Douglas GILBERTSON, Red Deer (CA)

(21) Appl. No.: 15/362,473

(22) Filed: Nov. 28, 2016

(30) Foreign Application Priority Data
Nov. 27, 2015 (CA) 2913291

(51) Int. Cl. G06Q 30/00; G06K 7/14; G06F 21/32; G06K 7/10; G06Q 50/26; G06Q 50/02

(52) U.S. Cl. CPC G06Q 30/018; G06Q 50/265; G06Q 50/02; G06F 21/32; G06K 7/10297; G06K 7/1413; G06K 7/1417; G06F 2221/2151

(57) ABSTRACT

A system is provided for generating confirmation signature pages for employees to evidence confirming events. The system comprises a physical unique identifier for each of the employees and an information handling system. The unique identifier may be an RFID tag. The information handling system comprises association means to uniquely associate each employee's digital signature with the employee's physical unique identifier. The information handling system further comprises confirmation means to generate a confirmation signature page when an employee utilizes his or her physical unique identifier to confirm a confirming event. The confirmation signature page provides a substantial reproduction of the digital signature of employee that utilized the physical unique identifier to confirm a confirming event.

### FIELD OF THE INVENTION

The present invention relates generally employee tracking systems and in particular to a system for tracking employee, entry and exit at work sites, tracking employee attendance at various health safety environment (HSE) meetings, acknowledging employee reading of safety materials and creating signature pages with the signatures of the employees confirming same.

### BACKGROUND OF THE INVENTION

In the oil and gas industry, and especially at oilfield well sites, safety of the employees is of paramount concern. It is therefore common for oilfield employees to have various safety training and other certifications. These certifications are also commonly referred to as “tickets”. Examples of such certifications or tickets include: (i) H2S Alive training, which is intended for workers in the petroleum industry who could be exposed to hydrogen sulphide (H₂S), (ii) first aid and CPR training, (iii) workplace hazardous materials information system (WHIMIS) training, (iv) transportation of dangerous goods (TDG) training, (v) all terrain vehicle (ATV) rider safety to bring ATV riders up to speed on proper riding techniques, and (vi) driver's license or vehicle operator license, which may be in one or more classes. It is important that each employee's certification or “ticket” is valid (i.e. not expired) when the employee is working on-site at an oilfield well site.

Oilfield well sites usually also employ onsite emergency medical services (EMS) personnel, also called a “medic”, whose job is to be on medical stand-by and provide emergency prehospital care in case an oilfield employee is injured while on site. This person may be an emergency medical responder (EMR), emergency medical technician (EMT), paramedic, nurse, or even a doctor. Now, with the increasing shift to ensure that all employees and workers at an oilfield well site have the appropriate training and tickets, fewer accidents occur. Thus, the majority of the time this onsite medic is simply waiting and watching. Because of this, the onsite medic is increasingly being given the responsibility to sign employees in and out of a well site.

Government regulations, oil company policies and oilfield safety consultant's procedures often require that an individual oilfield employee signs his or her name multiple times through a single work day. In addition to signing “into” a work site at the beginning of a work shift, and signing “out” of a work site at the end of that shift, oilfield employees and the like may also be requested to sign their name to confirm their attendance at one or more safety meetings and/or to confirm that they have read one or more “safe work permits” which typically outline the hazards found at a particular work site. This signature is used to confirm the employee's entry/exit onto the wellsite, their attendance at safety meetings and their having read particular safety and/or company policy materials.

Such a signature may then be referred to as a “confirmatory signature”, wherein the employee confirms a particular action or event. A record of these confirmatory signatures is kept by the oil company or the oilfield consultant, in case of accident and/or litigation, so as to serve as evidence when needing to assign or assess liability.

It is not unusual for an oilfield employee or worker to sign their name 5 to 6 times per day. It is also not unusual for an oilfield well site to employ 70 to 100 employees. This then places a significant burden on the medic to collect 350 to 600 confirmatory signatures in a day. In some cases, the medic may also have to “chase” down employees who may have forgotten to properly sign in, sign out or sign up. All together this results in the medic being distracted from his or her primary duty, which is to be on alert for any medical emergencies. Moreover, if that medic is called away during a medical emergency, this then causes an interruption in the collection of signatures, perhaps with a loss of opportunity to the oilfield company to collect the most relevant “confirmatory signatures”, namely the signatures of the oilfield employees in attendance during the day of the medical emergency. Therefore, what is needed is a system for generating automated or semi-automated confirmatory signature pages that reduces the workload on the medic and which may be able to function without the medic's constant supervision.

### BRIEF DESCRIPTION OF THE DRAWINGS

Referring to the drawings, several aspects of the present invention are illustrated by way of example, and not by way of limitation, in detail in the figures, wherein:

FIG. 1 is a simplified schematic illustrating one embodiment of the invention, illustrating collection of employee data;

FIG. 2 is a simplified schematic illustrating the embodiment of FIG. 1, illustrating two employees having signed in and a confirmatory signature page having been generated for these two employees by the invention;

FIG. 3 is a simplified schematic illustrating the embodiment of FIG. 1, illustrating three employees having signed in and a confirmatory signature page having been generated for these three employees by the invention; and

FIG. 4 is a simplified schematic illustrating the embodiment of FIG. 1, illustrating three employees attending a safety meeting and a confirmatory signature page having been generated for these three employees by the invention.

### DETAILED DESCRIPTION OF THE PREFERRED EMBODIMENTS

The following description is of a preferred embodiment by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

Referring to the Figures, a preferred embodiment of a system 10 for tracking employees 20 and generating employee confirmation signatures 100 and confirmation signature pages 110 is shown. The system 10 may be utilized at an oilfield wellsite W, having a perimeter P and an entrance E. The system 10 may also be utilized at any other type of worksite where employees 20 may be required to sign-in/sign-out, confirm attendance and/or confirm having read particular materials. Although the word employees is used, it is to be clear that this term is to include not only regular employees of a user of the system 10, but also comprises any other individuals who may enter the wellsite W or who otherwise might be requested to provide confirmation signatures 100, including independent contractors, freelancers, site visitors, and government site inspectors.

### Employee Data

The system 10 comprises an information handling system 11 which is preferably a server computer 11c having conventional processing, data storage, input and output means. The server computer 11c can be a unitary or a distributed system. For purposes of this disclosure, an information handling system 11 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, a smart phone, a tablet computer or any other suitable device and may vary in size, shape, performance, functionality, and price. The information handling system 11 may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system 11 may also include one or more buses operable to transmit communications between the various hardware components.

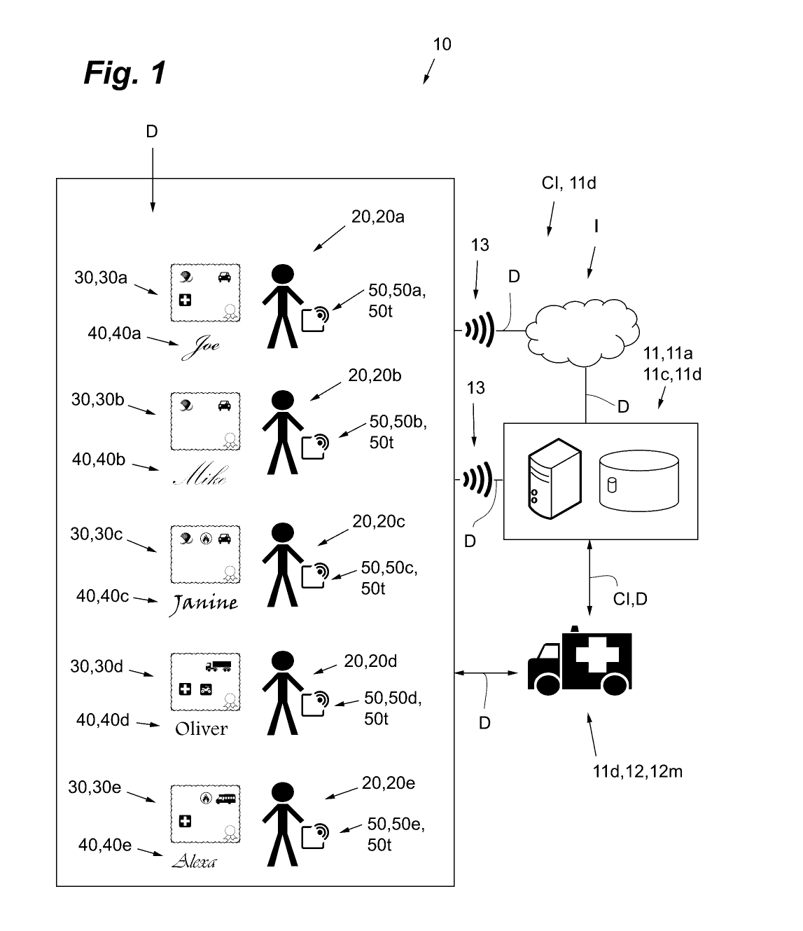

Preferably the system 10 comprises data entry means 11d to enter relevant employee data D into the information handling system 11. In a preferred embodiment of the system 10, data entry means 11d may further comprise an initial responsible representative 12 employed to communicate with the information handling system 11 and enter the relevant employee data D for each employee 20 into said information handling system 11 (see FIG. 1). The initial responsible representative 12 may utilize a conventional computer interface CI to enter relevant employee data D into the information handling system 11, such as a keyboard and monitor or similar terminal interface. The initial responsible representative 12 may be a medic 12m that is onsite at an oilfield wellsite W, a wellsite safety consultant, a human-resource employee of the oilfield company employing the system 10 or another party hired to enter employee data D into the information handling system 11.

In another embodiment, data entry means 11d may comprise a computer interface CI made available to allow one or more of the employees 20 themselves to enter his or her relevant data D into the information handling system 11. Preferably, said computer interface CI is a connection provided over the Internet I, via a web-based interface having suitable accounts, passwords and other confirmation and security and verification protocols to ensure secure and accurate entry of employee data D. In yet another embodiment, another party may already have some of the relevant employee data D entered into suitable format and such partial employee data D may then simply be imported or read into the information handling system 11 using conventional data-transfer and data-import techniques and means. Such other party may be a human-resource firm that already has some data about the employees 20. In yet still another embodiment, computer employee data D may be pre-loaded or pre-installed into the information handling system 11, prior to operation of the system 10. Data entry means 11d preferably comprises means to update, change and/or delete portions of the employee data D as may be needed or desired.

Employee data D may include personal information about the employee 20 (such as name, address, telephone number, email address, age). Employee data also preferably includes certification data 30 about the various certifications, tickets, licenses and training each particular employee 20 has (including data about any expiration dates of such certifications, tickets and licenses). More preferably, employee data comprises a digitized or digital version of each employee's signature, i.e. the employee's digital signature 40. Preferably, the employee's digital signature 40 is a graphic file that is a substantial reproduction of that employee's stylized hand-written script signature.

Such graphic file may be in compressed format, including lossless compressed format using suitable data compression algorithms such as the Lempel—Ziv—Welch (LZW) algorithm. Such lossless compression will allow the compressed digital signature to be an exact digital reproduction of the original (pre-compression) digital signature. Alternatively, the graphic file may be in a lossy compression format, such as JPEG format, wherein the degree of compression is adjusted to allow for a suitable tradeoff between storage size and image quality, wherein the image quality of the digital signature is then a substantial reproduction of any original (pre-compression) digital signature; said substantial reproduction preferably still being sufficiently suitable for evidentiary purposes in any court, tribunal or jurisdiction desired by the operator of the system 10.

The digital signature 40 may also be any other non-graphical digital signature, or electronic signature (e-signature), that is accepted by those in the relevant industry and/or defined by the relevant law of the jurisdiction in with the employee's company operates (e.g. the Personal Information Protection and Electronic Documents Act (PIPEDA) in Canada or the Uniform Electronic Transactions Act (UETA) in the United States.

During operation of the system 10, and for the purpose of generating confirmatory signature pages 110, the employees' data D of each particular employee 20 is preferably uniquely associated with the corresponding employee (e.g. 20a -20e) by means of a physical unique identifier 50 maintained, carried and controlled by said relevant employee. Further, during operation of the system 10, each of said plurality of physical unique identifiers 50 is uniquely associated with only the corresponding employee whose data D is associated with that employee. Should a particular physical unique identifier 50 be lost, stolen or otherwise become inoperative, such lost, stolen or otherwise inoperative identifier 50 may be disassociated from said corresponding employee and a new physical unique identifier 50 may then be uniquely associated with said corresponding employee.

The physical unique identifier 50 may be a bar code, a quick response (QR) code, a near field communication (NFC) chip inside a smart-phone, or even a finger print or other suitable biometric identifier. Preferably, the physical unique identifier 50 is a radio-frequency identification (RFID) tag 50t. Such radio-frequency identification (RFID) tags may be in the form of a card, label, fob, microchip or bracelet. Suitable and cost-effective RFID tags for use in the oil & gas industry may be obtained from Libramation Inc. of Edmonton, Alberta. More preferably, the tag 50t is an RFID tag having a built-in digital certificate of authenticity, so as to further ensure authenticity of each particular tag 50t and allow for secure association of each tag 50t with each particular employee 20a-20e.

Advantageously, an RFID tag 50t may be quickly scanned, swiped, read or checked using an RFID reader 13r with only minimal supervision by a responsible representative 12, and with minimal (if any) action on the part of the employee 20. Such employee 20 will thereby be relieved of physically having to sign their hand-written signature and be more inclined or motivated to confirm a event, action or the like. More advantageously, RFID technology is less costly than current biometric readers and scanners and, moreover, does not require that every employee has an expensive smart phone with a NFC chip. Even more advantageously, an RFID tag 50t embedded in a bracelet will allow the employee 20 to remove the unique identifier 50 when not at work. Yet even more advantageously, an RFID tag 50t can also be made in rugged form to withstand the typical environmental and climate extremes experienced by oilfield workers. In contrast, a bar code on a card, a QR code printed on a worker's helmet, or the worker's finger print may become smudged or covered with mud, grease or oil, thereby potentially complicating subsequent reading or scanning of the identifier 50. An RFID tag 50t inside a bracelet, fortunately, will not usually be affected by mud, grease or oil that is common place at an oilfield wellsite W.

In the embodiment of FIGS. 1-4, there are shown five employees (20a-20e), each having: individualized certification data (30a-30e), a unique digital signature (40a-40e) and a distinct physical unique identifier (50a-50e). The information handling system 11 contains association means 11a such as conventional programming and databases to associate the individualized certification data (30a-30e), the unique digital signature (40a-40e) and the distinct physical unique identifier (50a-50e) with each of the relevant employees (20a-20e). This may be accomplished by further providing a virtual unique identifier, such as a unique database entry code or key, for each of the relevant employees (20a-20e) and then associating the relevant employee's certification data, digital signature and physical unique identifier with that virtual unique identifier within the information handling system 11. It is clear to those skilled in the art that such data association may be accomplished by any number of database management systems, including the open-source MySQL relational database management system.

### Obtaining Confirmation Signatures

During operation, and once the relevant employee data D is within the information handling system 11 and said data D is associated with any relevant employees (20a-20e), a confirmation means 11m is preferably employed to obtain one or more confirmatory signatures 100 and/or to generate confirmation signature pages 110, when one or more of the employees 20 confirm a particular action or event. Such particular action or event may also be referred to as a confirming event. Confirmation signature pages 110 may be generated upon command (e.g. upon a query by a user of the system 10), at predetermined intervals (e.g. at the start or conclusion of a safety meeting) or in real-time or almost real-time (e.g. when created in electronic format and updated in real-time as additional employees 20 confirm particular confirming events).

Confirmation means 11m may further comprise a successive responsible representative 12s who is preferably provided with access to the information handling system 11. The successive and initial responsible representatives 12,12s may be the same individual, but typically are different individuals for larger entities or during different shift periods at a wellsite W. The successive responsible representative 12s could also be a superior of the initial representative 12 or a third-party.

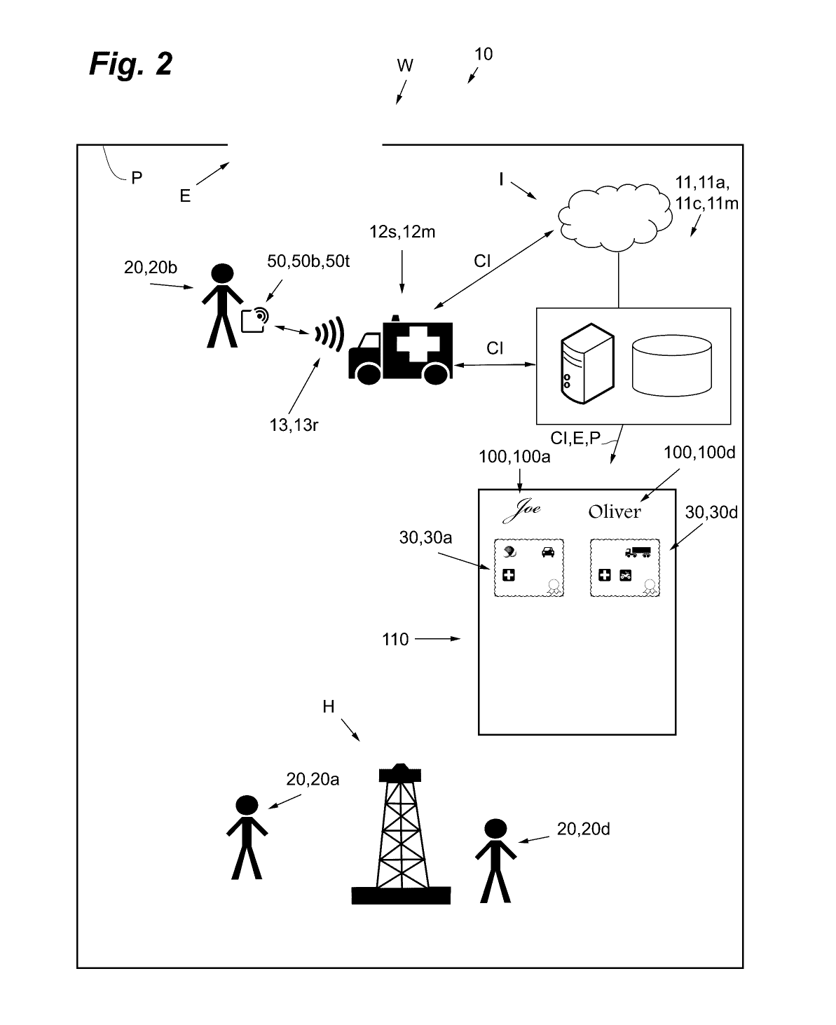

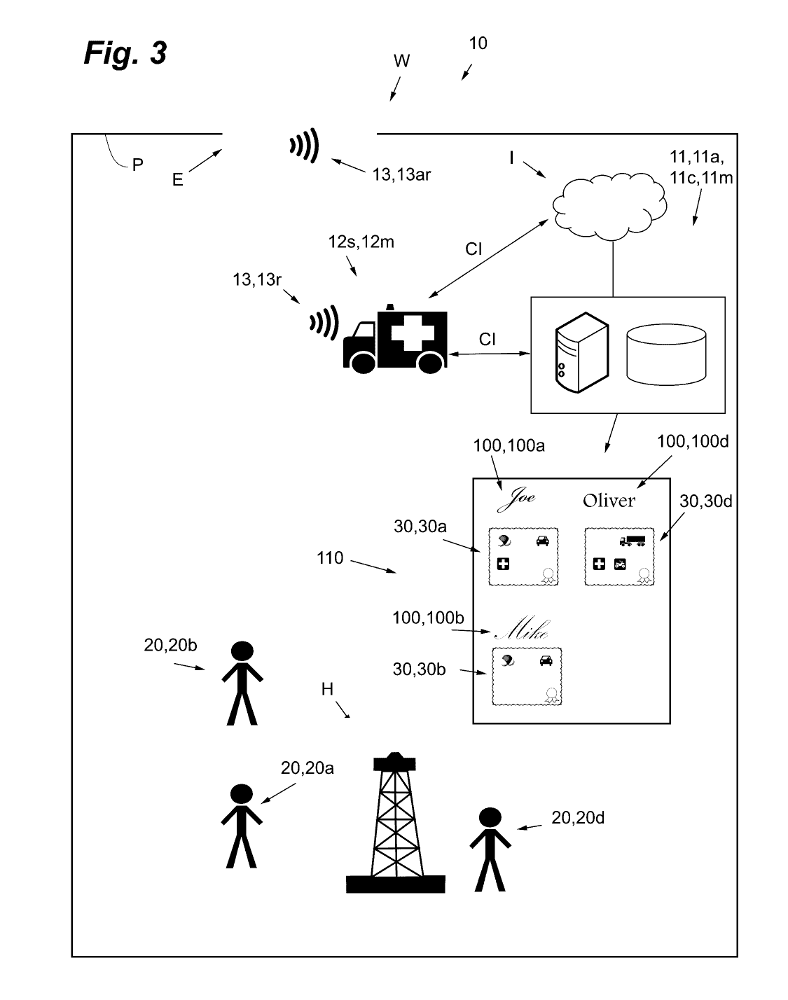

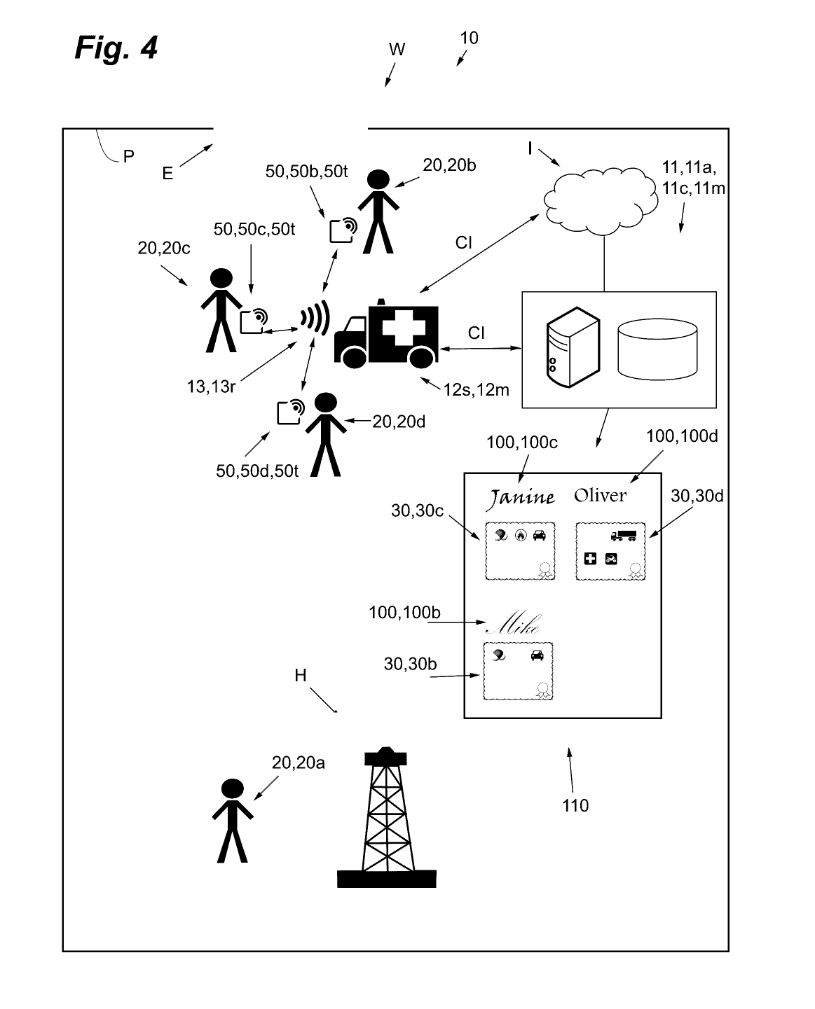

The successive responsible representative 12s may be tasked with utilizing the system 10 to obtain one or more confirmatory signatures 100 and/or generating confirmation signature pages 110, when one or more of the employees 20 confirm a particular action or event. Typical actions or confirming events that may result in confirmatory signatures and/or confirmatory signature pages are: during employee sign-in/sign-out events (e.g. FIGS. 2-3), at safety meeting events (e.g. FIG. 4) and to confirm employees 20 having read particular safe work permit materials (not shown). Accordingly, any successive responsible representative 12s will normally attend the wellsite W location. The successive responsible representative 12s may be the medic 12m on duty and may be set up, or be stationed at, a convenient location on the wellsite W, such as near the entrance E or at a “muster” point.

The successive responsible representative 12s may utilize a data collecting device 13 capable of communication with the information handling system 11 to document or enter particular confirming events. When using RFID tags 50t as the physical unique identifier 50, the data collecting device 13 may be a convenient and typical RFID reader 13r. The RFID reader 13r may be a handheld reader for ease of operation by the successive personal representative 12s. In certain embodiments of the system 10, a plurality of successive responsible representatives 12s may be provided, for example at a plurality of entrances E or muster points.

In certain other embodiments of the system 10, confirmation means 11m may comprise automated data collecting devices 13 which may operate without continuous supervision of a human successive responsible representative 12s. For example, an automated RFID reader 13ar may be implemented at a convenient location of the oilfield well site W, such as near the entrance E (e.g. see FIG. 3) or at a muster point, and allow employees 20 to simply swipe, read or scan their RFID tag 50t, thereby triggering the system 10, and the information handling system 11, to automatically create a confirmatory signature 100 and/or a confirmatory signature page 110 for the confirming event. Automated RFID readers 13ar may also be configured using conventional means to automatically read, identify or scan all RFID tags 50t present within a certain distance or radius from such automated reader 13ar. In such embodiments, the simple act of an employee 20 wearing or otherwise carrying his or her RFID tag 50t will cause the confirmation means 11m to trigger and create a confirmatory signature 100 and/or a confirmatory signature page 110 for the confirming event, all without need for additional human involvement or further action on the part of the employee 20. Preferably, the automated RFID readers 13ar may positioned adjacent the well site's entrance(s) E and also be configured with a scanning distance or radius using conventional means to automatically read or scan all RFID tags 50t that physically pass through such entrance(s) E. Advantageously, such a configuration of the automated RFID readers 13ar will ensure that all, or substantially all, employees 20 which pass through the entrance(s) E trigger the confirmation means 11m to generate one or more confirmatory signature pages 110 to evidence said employees 20 having entered or exited the well site W.

Additional automated RFID readers may be provided at different locations within the wellsite W or outside the wellsite W (e.g. just outside an entrance E) to allow the system 10 to create a geographic or location-based record of employee 20 triggering events in and around a wellsite W. The information handling system 11 may be provided with conventional geographic information system (GIS) programming and functionality wherein such plurality of automated RFID readers are mapped or associated with spatial information. Advantageously, on well sites W with a very large number of employees 20, such automated RFID readers 13r will ensure quick generation of confirmatory signatures 100 and/or confirmation signature pages 110, with minimal demand on the time and attention of the medic 12m on duty. More advantageously, such automated RFID readers 13r will also allow for the generation of confirmatory signatures 100 and/or confirmation signature pages 110 when the medic 12m may be occupied with a medical emergency.

Even more advantageously, when utilizing a plurality of automated RFID readers at various locations in and/or around the wellsite, any geographic or location-based information can be utilized by a user of the system 10 to create a record of employee location and whereabouts on or around a wellsite W. This may allow such a user of the system 10 to track employees 20 to ensure that only qualified individuals enter particular areas of the wellsite W; e.g. employees with valid H2S Alive tickets should enter areas of the wellsite where there are hydrogen sulfide (H2S) risks. Conventional programming and databases management technique can then also be utilized to compare employees' 20 certification data 30 with preset values (e.g. minimum ticket requirements) and send alarms, warnings or alerts to a user of the system 10 when employees 20 trigger automated RFID readers 13r in locations on a wellsite W where such employees may not be qualified to be.

The confirmatory signature page 110 may be a hard-copy printed P by the information handling system 11 using conventional means such as a printer, or it may be an electronic “page” or document in a file format presented in a manner independent of application software, hardware, and operating systems, e.g. in portable document format (PDF). Such electronic PDF document may be generated by the information handling system 11 using conventional, automated or semi-automated, software typically used to create electronic PDF documents. When in electronic format, access to the signature pages 110 may be provided to a user of the system 10 by means of a computer interface CI to the information handling system 11 (e.g. by displaying one or more signature pages 110 on a computer monitor or screen), or the electronic signature pages 110 may be sent by electronic mail (email) E to a user of the system 10. When in a hard-copy paper format, such confirmatory signature pages 110 may be printed P on paper using conventional printers, and wherein each employee's 20 digital signature 100 is preferably reproduced on the hard-copy paper in such dimensions and at such resolution and scale so as to be a substantial reproduction of said employee's 20 hand-written script signature. Advantageously, such reproduction hard-copy of a particular employee's hand-written script signature may then be more readily accepted (by relevant parties, such as a court or tribunal) as evidence that said particular employee did indeed confirm the confirming event. More preferably, the user of the system 10 may request that any employees 20 enter into a written agreement wherein (i) the confirmation means 11m is authorized to reproduce the employee's 20 digital signature when triggered and (ii) that any such reproduction of their digital signature 100 is deemed to have the same effect as the employees having physically signed their hand-written script signature to confirm a confirming event.

The confirmatory signature pages 110 may be date- and time-stamped in a conventional manner, including electronic date- and time-stamping when said pages 110 are in electronic format. Confirmatory signature pages 110 may be collected by the medic 12m, the wellsite supervisor, or maintained in electronic format within the system 10 and available for download by appropriate personnel and representatives of the company using the system 10. Confirmatory signature pages 110 may be forwarded to a third-party for safe keeping, archiving and confirming any date- and/or time-stamp. If in electronic format, the confirmatory signature pages 110 may be sent to a user of the system 10, a medic 12m, a wellsite supervisor or to a third-party via electronic mail (email) or other suitable electronic transmission means (e.g. SMS messaging as an image file). Such user of the system 10, medic 12m, wellsite supervisor or third party could then provide any one or more of the signature pages 110 to serve as evidence when needing to assign or assess liability in case of accident or litigation. Any data- and/or time-stamping could then provide even further evidence in such cases.

The information handling system 11 may be accessible to the initial responsible representative 12, and to the successive responsible representative(s) 12s, in any number of conventional ways, including through a distributed network such as the Internet I and using suitable conventional computer interfaces Cl. However, the information handling system 11 may also be a stand-alone computer 11c, with data D being uploaded and downloaded via computer readable media (such as diskettes, CD's, DVD's, memory sticks, memory cards) or other means such as wireless communications (IR, Blue-tooth or WiFi) or input devices (such as keyboards, RFID readers 13r and optical scanners). Additional output from such stand-alone computer 11c may be provided to a user of the system 10 in a conventional manner, such as via computer displays, screens or monitors and audio our sound output devices such as speakers or headphones.

### EXAMPLES

FIGS. 2 and 3 illustrate different stages of employee sign-in events. In FIG. 2, individual employees 20a and 20d have completed their “sign-in” tasks and the information handling system 11 has generated a confirmation signature page 110 which displays their particularized certification data 30a, 30d along with their confirmatory signatures 100a, 100d. These employees 20a, 20d are now shown working adjacent the wellhead H. Employee 20b is in the process of “signing in”, but has not yet completed this event. That employee 20b is shown positioned next to the medic 12m who may be tasked as the successive responsible representative 12s. Accordingly, the confirmatory signature page 110 in FIG. 2 does not show the certification data 30b and confirmatory signature 100b for employee 20b.

In FIG. 3, employee 20b has completed the “sign-in” task and the information handling system 11 has now generated a confirmation signature page 110 which displays the particularized certification data 30a, 30b, 30d and confirmatory signatures 100a, 100b, 100d for all three of the employees 20a, 20b, 20d. These employees are now shown working adjacent the wellhead H.

FIG. 4 illustrates a safety meeting held by the medic 12m acting as the successive responsible representative 12s. During this particular safety meeting, employees 20b, 20c and 20d have had their unique physical identifier 50b, 50c, 50d scanned by the RFID reader 13 so as to confirm that they each have read one or more “safe work permits” outlining the hazards found at this particular work site W. Accordingly, the information handling system 11 then generated a confirmation signature page 110 which displays the particularized certification data 30b, 30c, 30d and confirmatory signatures 100b, 100c, 100d for employees 20b, 20c, 20d. Employee 20a is shown as remaining adjacent the wellhead H and not having attended the safety meeting. Accordingly, the confirmatory signature page 110 in FIG. 4 does not show the certification data 30a and confirmatory signature 100a for employee 20a; since employee 20a did not attend that particular safety meeting.

Advantageously, the use of signature pages 110 provides confirmation of particular employees' entry/exit onto the wellsite, their attendance at safety meetings and/or their having read particular safety and/or company policy materials. More advantageously, by also displaying and containing the certification data 30, the signature pages 110 provide information as to each employee's current tickets, any missing ticket requirements and/or any expired tickets. As such, the signature pages 110 allow an operator of the system 10 to ensure that particular employees are fit to working at a particular well site on a particular date.

Even more advantageously, the use of a server computer 11c along with the use of an electronic RFID reader 13r, allows for the system 10 to rapidly and efficiently conduct the step that previously could not readily or efficiently be performed by a human medic using manual or mental means, namely to prepare a large number of confirmatory signature pages 110 for each of the employees 20a -20e attending a plurality of confirming events. More advantageously, the use of an automated RFID reader 13r allows the system to reduce number of, or eliminate all together, the successive responsible representatives 12s, without the need for a human medic or other human personnel. Yet even more advantageously, the use of confirmatory signature pages 110 in portable document format (PDF) allows for an operator of the system 10 to quickly and easily retrieve and then view said pages 110 (e.g. via a push notification or email to a smart phone with the PDF as an attachment), including in remote well-site locations, without the need for a human to physically search for, retrieve and bring up a physical paper pages.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

The embodiments of the invention in which an exclusive property or privilege is being claimed are defined as follows:

1. A system for generating confirmation signature pages for one or more employees to evidence one or more confirming events, the employees each having a digital signature, the system comprising:
a physical unique identifier for each of said plurality of employees;
an information handling system;
wherein the information handling system further comprises:
association means to uniquely associate each employee's digital signature with that employee's physical unique identifier; and
confirmation means to generate at least one confirmation signature page when said one or more employees utilizes his or her physical unique identifier to confirm a confirming event;
wherein said at least one confirmation signature page contains a substantial reproduction of the digital signature of each of said one or more employees that utilized his or her physical unique identifier to confirm a confirming event.

2. The system of claim 1, further comprising data entry means to enter employee data into the information handling system.

3. The system of claim 2, wherein the data entry means further comprises an initial responsible representative to enter relevant employee data into the information handling system.

4. The system of claim 2, wherein the data entry means further comprises a computer interface made available to the one or more employees and allow said one or more employees to enter their own employee data into the information handling system.

5. The system of claim 1 wherein the employee data for each employee includes at least a substantial reproduction of that employee's digital signature.

6. The system of claim 5 wherein the employee data further comprises certification data for at least one of said one or more employees.

7. The system of claim 1 wherein the physical unique identifier is any one of a bar code, a quick response code, a near field communication chip inside a smart-phone or a biometric identifier.

8. The system of claim 1 wherein the physical unique identifier is a radio-frequency identification tag.

9. The system of claim 1 wherein the association means is programmed database management system.

10. The system of claim 8 wherein the confirmation means further comprises a successive responsible representative who is preferably provided with access to the information handling system.

11. The system of claim 8 further comprising at least one data collecting device capable of communication with the information handling system.

12. The system of claim 11 wherein the at least one data collecting device are RFID readers.

13. The system of claim 12 wherein at least one of the RFID readers is an automated RFID reader.

14. The system of claim 1 wherein the at least one confirmation signature page is a hard-copy paper page.

15. The system of claim 1 wherein the at least one confirmation signature page is an electronic document.

16. The system of claim 1 wherein the at least one confirmation signature page is date- and time-stamped.

17. The system of claim 13 utilized at an oilfield wellsite having a perimeter and at least one entrance and wherein the at least one automated RFID reader is positioned adjacent the at least one entrance and is configured to automatically scan all employee RFID tags that physically pass through said at least one entrance.
